(19) United States
(12) Patent Application Publication
(10) Pub. No.: US 2026/0259725 A1
(43) Pub. Date: Sep. 3, 2026

(54) SECURE MANAGEMENT OF VEHICLE-TO-VEHICLE OVER-THE-AIR UPDATES USING A BLOCKCHAIN

(71) Applicant: HARMAN INTERNATIONAL INDUSTRIES, INCORPORATED, Stamford, CT (US)

(72) Inventor: Amruth ANNEGOWDA, Bengaluru (IN)

(73) Assignee: HARMAN INTERNATIONAL INDUSTRIES, INCORPORATED, Stamford, CT (US)

(21) Appl. No.: 19/489,489

(22) PCT Filed: Jun. 2, 2023
(86) PCT No.: PCT/US2023/067831

§ 371 Date: Dec. 2, 2025

(51) Int. Cl. G06F 8/65; H04L 9/00; H04W 4/46

(52) U.S. Cl. CPC G06F 8/65; H04L 9/50; H04W 4/46

(57) ABSTRACT

Methods and systems are provided for managing over-the-air (OTA) software updates between vehicles and a vehicle management system. In one example, an over-the-air (OTA) update system for a vehicle comprises a streaming service configured to request an OTA update from a second vehicle; a blockchain including a contract executing virtual machine (VM), the contract executing VM configured to execute, in response to receiving a response to the request from the second vehicle, a first smart contract stored on the blockchain including instructions that when executed, cause the contract executing VM to download the OTA update from the second vehicle, and install the OTA update at the vehicle. Installing the OTA update at the vehicle may include validating the OTA update against a plurality of other copies of the blockchain installed at other vehicles prior to installation.

### TECHNICAL FIELD

The present description relates to methods and systems for managing over-the-air (OTA) updates to vehicle software.

### BACKGROUND/SUMMARY

A vehicle manufacturer may periodically release new versions of software running at their vehicles. To ensure that the vehicles are operating using a most recent version, the new versions or patches may be transmitted by the manufacturer to the vehicles via over the air (OTA) updates. During an OTA update, a package including the new version may be transmitted from a server of a manufacturer to a plurality of vehicles of a vehicle fleet. After the new version has been downloaded by a vehicle, the new version is installed in place of a previous version.

However, the vehicle fleet may be large, and rolling out a new version of the software to the plurality of vehicles may be time consuming and computationally intensive. Additionally, transmitting the new versions may rely on internet connectivity via a wireless network, which may be inconsistent, of low quality, costly, and/or not be available at certain places and/or times.

One solution to disseminating and installing OTA updates without relying on a wireless network is to use vehicle-to-vehicle (V2V) communication, where a vehicle not including the OTA update may receive the OTA update from a neighboring vehicle rather than via a wireless network. For example, U.S. Pat. No. 9,274,785 to Jung teaches updating software at a vehicle via wireless communication with a neighboring vehicle. However, the transfer of the OTA update may be insecure, where a malicious intruder may access the OTA update during the transfer and alter the OTA update to gain access to or control of the vehicle.

In one embodiment, the problems described above may be addressed by an over-the-air (OTA) update system for a vehicle, the OTA update system comprising a streaming service configured to request an OTA update from a second vehicle; a blockchain including a contract executing virtual machine (VM), the contract executing VM configured to execute, in response to receiving a response to the request from the second vehicle, a first smart contract stored on the blockchain including instructions that when executed, cause the contract executing VM to download the OTA update from the second vehicle, and install the OTA update at the vehicle. Downloading and installing the OTA update at the vehicle may include establishing a wireless connection between the vehicle and the second vehicle; downloading the OTA update from the second vehicle via the wireless connection; submitting a transaction to add the OTA update to the blockchain, verifying the transaction with a plurality of other copies of the blockchain installed at other vehicles; and in response to the transaction being verified, installing the OTA update at the vehicle.

The OTA update system may include a computer application for implementing a version of a streaming service, which may be launched in an electronic control unit (ECU) of the vehicle. When the streaming service is implemented, a contract executing VM embedded in the blockchain may receive the event data from the streaming service installed at the vehicle. If the contract executing VM determines that the one or more conditions of one or more smart contracts for managing an OTA update have been met, transmission of an update package may be automatically initiated. By storing version data of software running at vehicles in a distributed fashion across a plurality of copies of the blockchain installed at a respective plurality of vehicles, a validity of the version data may be verified at any time by consulting the one or more of the copies of the blockchain, thereby increasing a security of the vehicle and decreasing a possibility of an unauthorized access or use of the vehicle. Further, execution of the smart contracts and control of the OTA updates may be performed between vehicles, without involving the vehicle management system. As a result, the updates may not rely on an availability of the vehicle management system or a quality of a wireless connection between the vehicle and the vehicle management system, resulting in a more robust and independent updating of the vehicle in accordance with the smart contracts.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

Various aspects of this disclosure may be more clearly understood upon reading the following detailed description and upon reference to the drawings in which:

FIG. 1 is a schematic block diagram of an exemplary vehicle management system, according to an embodiment;

FIG. 2 is a flowchart that illustrates an exemplary method for receiving and installing an OTA update of vehicle software stored on a blockchain, according to an embodiment;

FIG. 3 is a flowchart that illustrates an exemplary method for a providing a first vehicle with an OTA update of vehicle software stored on a blockchain, from a second vehicle, according to an embodiment;

FIG. 4 is a timing diagram showing a wireless transfer of a software update package between a plurality of vehicles of a vehicle fleet, according to an embodiment; and

FIG. 5 is a diagram illustrating a configuration of cars receiving an OTA update, according to an embodiment.

The drawings illustrate specific aspects of the described systems and methods. Together with the following description, the drawings demonstrate and explain the structures, methods, and principles described herein. In the drawings, the size of components may be exaggerated or otherwise modified for clarity.

### DETAILED DESCRIPTION

The following description relates to systems and methods for managing over-the-air (OTA) software updates for a vehicle, where versions of software being updated are stored in a distributed ledger system such as on a blockchain. In accordance with the proposed OTA update system, a vehicle with a less recent version of software may receive an updated version of the software from a second vehicle having a more recent version of the software, rather than receiving the updated version from a vehicle management system of a manufacturer of the vehicle via a wireless internet connection. By storing updated versions of the software in the distributed ledger system, a secure, immutable record of versions of the software running at each vehicle of a vehicle fleet may be maintained. By transmitting the OTA updates from a sending vehicle to a receiving vehicle rather than via a wireless distribution from a central server, the OTA updates may be disseminated faster and using less computational resources, while decreasing a reliance on network connectivity and/or availability. As a result, a functioning of the OTA update system may be increased and/or improved.

A distributed ledger is a transactional record that is maintained at each node of a decentralized, peer to peer (P2P) network. Commonly, the distributed ledger is comprised of groupings of blockchain transactions bundled together into a “block.” When a change to the distributed ledger is made (e.g., when a new blockchain transaction and/or block is created), each node forms a consensus as to how the change is integrated into the distributed ledger. Upon consensus, the agreed-upon change is pushed out to each node so that each node maintains an identical copy of the updated distributed ledger. Any change that does not achieve a consensus is ignored. Accordingly, unlike a traditional, centralized ledger, a single party cannot unilaterally alter the distributed ledger.

In one application of distributed ledgers, each new block may be cryptographically linked to the previous block in order to form a chain (e.g., a blockchain). More particularly, to create a new block, each blockchain transaction within a block may be assigned a hash value (e.g., an output of a cryptographic hash function, such as SHA-2 or MD5). These hash values may then be combined together utilizing cryptographic techniques (e.g., a Merkle Tree) to generate a hash value representative of the entire new block. This hash value may then be combined with the hash value of the previous block to form a hash value included in the header of the new block, thereby cryptographically linking the new block to the blockchain. To this end, the precise value utilized in the header of the new block is dependent on the hash value for each blockchain transaction in the new block, as well as the hash value for each blockchain transaction in every prior block.

In some embodiments, the hash value generated for the new block may be used as an input to a cryptographic puzzle that manipulates a nonce value. When a solution to the cryptographic puzzle is found, the solving node publishes the solution and the other nodes then verify that the solution is the correct solution, Because the solution may also depend on the particular hash values for each blockchain transaction within the blockchain, if the solving node attempted to modify any blockchain transaction, the solution would not be verified by the other nodes. More particularly, if a single node attempts to modify a prior blockchain transaction within the blockchain, a cascade of different hash values are generated for each tier of the cryptographic combination technique. This results in the header for one or more blocks being different than the corresponding header(s) in every other node that did not make the exact same modification. As a result, the solution generated by the modifying node would not solve the cryptographic puzzle presented to any node without the identical modification. Thus, the version of the new block generated by the modifying node is readily recognized as including an improper modification and is rejected by the consensus. This inability to modify past blockchain transactions lead to blockchains being generally described as trusted, secure, and/or immutable.

For an OTA software update system based on a distributed ledger, software version data may be written to blocks of the blockchain as described above. In this way, the software version data may be stored in an immutable manner.

A smart contract is a computer protocol that enables the automatic execution and/or enforcement of an agreement or transaction between different parties. In particular, the smart contract may be computer code that is located at a particular address on the blockchain, The smart contract may include one or more trigger conditions, that, when satisfied, correspond to one or more actions. For some smart contracts, which action(s) of the one or more actions are performed is determined based upon one or more decision conditions. The contract executing VM executing the smart contract may subscribe to one or more data streams including data related to a trigger condition and/or a decision condition. Accordingly, the contract executing VM may route the data streams to the smart contract so that the smart contract may detect that a trigger condition has occurred and/or analyze a decision condition to direct the enforcement entity to perform one or more actions.

By recording a smart contract in the distributed ledger, there is a public and trusted record of the smart contract and the reasoning behind actions performed as directed by the smart contract. As a result, parties that generate a smart contract may rely on an automatic enforcement of their contracts in a transparent and objective manner. The distributed ledger may either be a public ledger (each node may readily view the underlying data of each blockchain transaction) or a private ledger (the underlying data needs an encryption key to be viewed), or a combination of public and private ledger.

As described herein, a smart contract for managing a transmission of a more recent version of a software program from a first vehicle to a second vehicle may be stored on a blockchain of the OTA software update system at either or both of the first vehicle and second vehicle. The smart contract may be triggered when a distance between the first vehicle and the second vehicle is less than a threshold distance. The smart contract may be automatically executed based on real-time event data received at the contract executing VM embedded in the blockchain. The real-time event data may be transmitted from a streaming service running at the vehicle, and may include, for example, software version information and/or other data of a respective vehicle.

Performing the OTA software updates between vehicles rather than via a transmission from the vehicle management system may be advantageous for various reasons. An OTA update may be performed more quickly between vehicles, where communication between a vehicle and the vehicle management system may not be relied on. For example, the communication may be delayed or unavailable due to network or technical issues. A use of processing and memory resources by the vehicle management system may be reduced, increasing a general efficiency of the vehicle management system. Additionally, by storing version information on the blockchain and verifying the software updates against the blockchain, the software may be transmitted and installed in a more secure fashion than via a centralized OTA update.

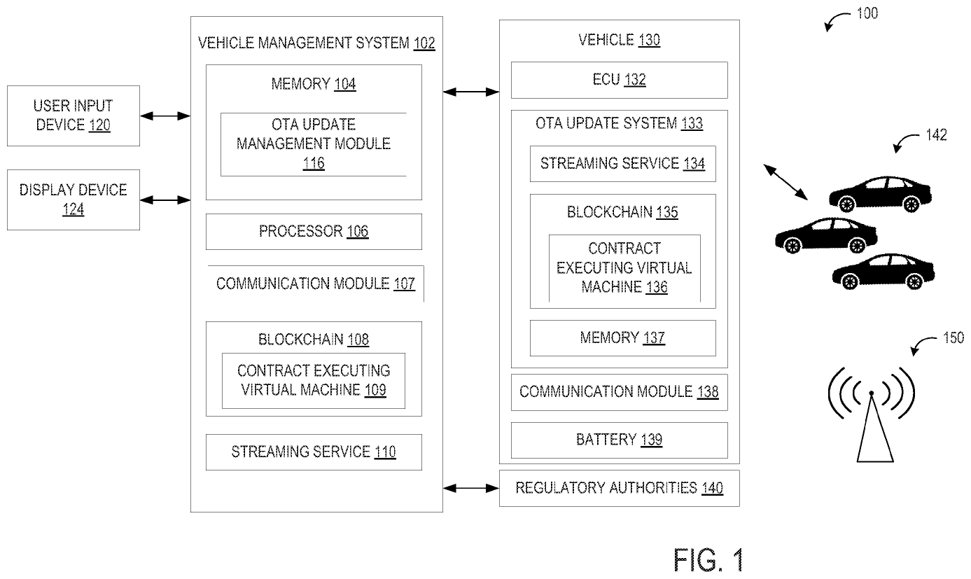

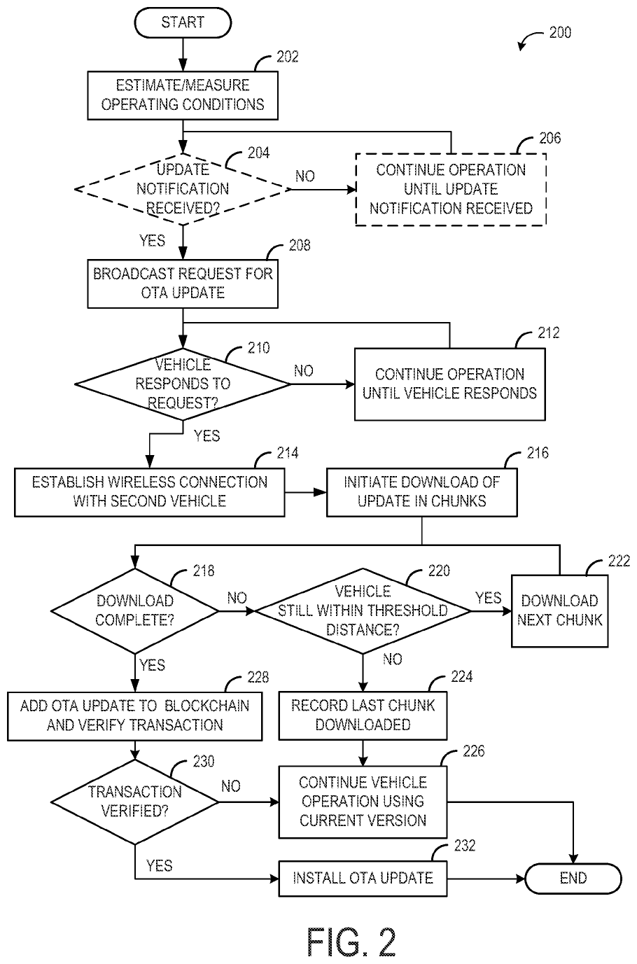

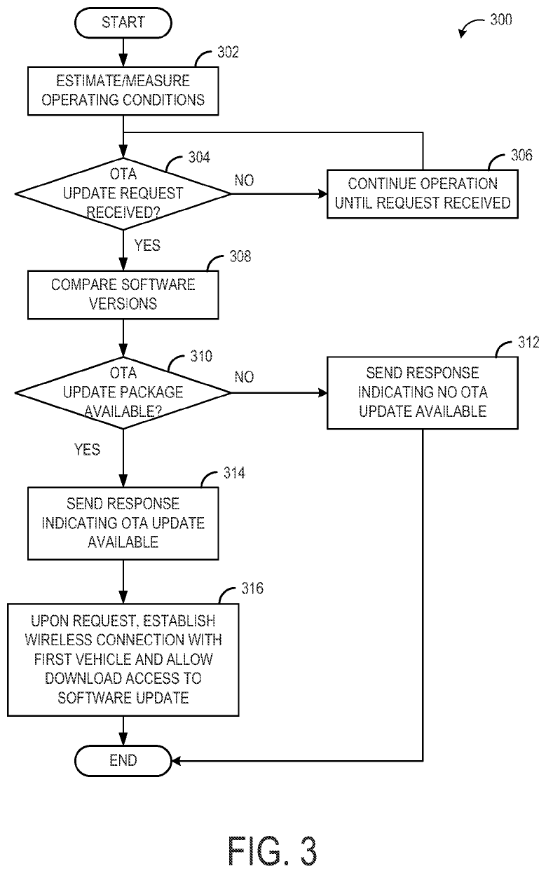

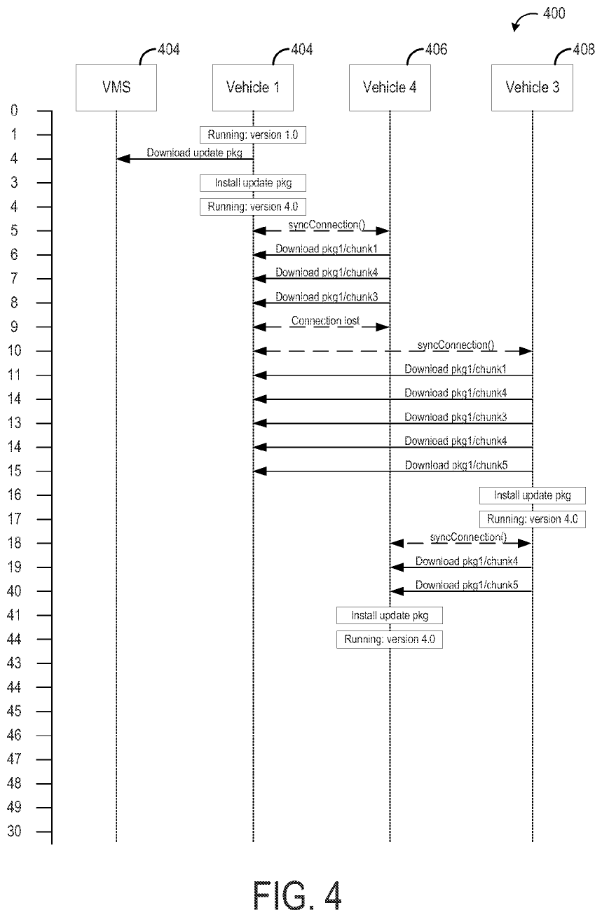

FIG. 1 shows a vehicle ecosystem including a vehicle management system, The vehicle management system includes a blockchain, which may store version information of software programs running on various vehicles of a vehicle fleet. A software program of the software programs may be automatically updated (e.g., without human intervention) at a vehicle of the vehicle fleet when the vehicle is within a threshold proximity of a second vehicle running a more recent version of the software program, as shown in FIG. 2. A first vehicle may request and receive an OTA update from a second vehicle by following one or more steps of the method provided in FIG. 3. The second vehicle may respond to the request and provide the OTA update by following one or more steps of FIG. 4.

FIG. 1 shows a vehicle ecosystem 100, including a vehicle management system 102, Vehicle management system 102 may be used to manage periodically updating software at a vehicle 130, where vehicle 130 may be a member of a vehicle fleet 142. In some embodiments, vehicle fleet 142 may include vehicles that are the same or similar. For example, vehicle fleet 142 may include vehicles of a same make and/or model, or of similar makes and models that may operate using similar software. In various embodiments, vehicle management system 102 may be operated by a manufacturer of vehicle 130 and/or vehicle fleet 142.

Vehicle 130 may be a car, a bus, a truck, or a different type of machinery or vehicle operated by an operator. Vehicle 130 may be powered by an internal combustion engine, or vehicle 130 may be an electric vehicle powered by an electrical power source, or vehicle 130 may be a hybrid vehicle powered by both an internal combustion engine and an electrical power source. Vehicle 130 may also be a specialized vehicle used in a specific environment, such as, for example, a golf cart or transportation vehicle used in certain areas of a private facility such as an indoor facility. Vehicle 130 may be operated on public and/or private roads and highways, or on a set of tracks or rails (e.g., a train). In general, vehicle 130 may be any type of vehicle operated by an operator.

Vehicle management system 102 includes one or more processors 106 configured to execute machine readable instructions stored in non-transitory memory 104. Memory 104 and other memory referred to herein may include one or more data storage structures, such as optical memory devices, magnetic memory devices, or solid-state memory devices, for storing programs and routines executed by processor(s) 106 to carry out various functionalities disclosed herein. Memory 104 may include any desired type of volatile and/or non-volatile memory such as, for example, static random access memory (SRAM), dynamic random access memory (DRAM), flash memory, read-only memory (ROM), etc.

Memory 104 may include an OTA update management module 116, which may manage a dissemination of OTA updates to one or more vehicles 130 of vehicle fleet 142. For example, software running at the one or more vehicles 130 may be periodically updated via an OTA update. OTA update management module 116 may store and keep track of different OTA updates sent out over time. Additionally, OTA update management module 116 may transmit notifications to the one or more vehicles 130 indicating an availability of an OTA update. Each OTA update may be relevant to a software program or application running at the one or more vehicles 130. The OTA update may be made available to the one or more vehicles 130 via V2V communication, as described in greater detail below.

Processor(s) 106 and other processors referred to herein may be any suitable processor, processing unit, or microprocessor, for example. Processor(s) 106 may be a multi-processor system, and, thus, may include one or more additional processors that are identical or similar to each other and that are communicatively coupled via an interconnection bus. Processor(s) 106 may be single core or multi-core, and the programs executed thereon may be configured for parallel or distributed processing. In some embodiments, processor(s) 106 may optionally include individual components that are distributed throughout two or more devices, which may be remotely located and/or configured for coordinated processing. In some embodiments, one or more aspects of processor(s) 106 may be virtualized and executed by remotely-accessible networked computing devices configured in a cloud computing configuration.

Vehicle management system 102 may include a communication module 107, which may manage wireless communication between vehicle management system 102 and a communication module 138 of vehicle 130. For example, communication module 107 may communicate with communication module 138 via a wireless network 150. In various embodiments, wireless network 150 may be or include the Internet. For example, an OTA update may be sent from vehicle management system 102 to one or more vehicles 130 over the Internet via a cell phone network. In other embodiments, wireless network 150 may be or include one or more private networks. For example, an OTA update may be sent from vehicle management system 102 to one or more vehicles 130 parked in a lot at a location of vehicle management system via a private wireless network. The OTA update may be downloaded from communication module 107 by one or more respective communication modules 138 of the one or more vehicles 130.

Vehicle management system 102 may include a blockchain 108, which may be used by vehicle management system 102 as a distributed ledger to store OTA update and version information for software running at vehicle 130. For example, critical updates may be periodically released as security patches, such as every 2-3 months. Other updates may be performed as well, such as, for example, welcome screen updates, map data updates, etc. Blockchain 108 may include a contract executing virtual machine (VM) 109 (e.g., an oracle) that may execute one or more smart contracts included in blockchain 108. Additionally, vehicle management system 102 may include a streaming service 110, which may stream data that may be received by contract executing VM 109 and/or other contract executing VMs of various vehicles 130 (e.g., contract executing VM 136). Additionally, real-time event data from vehicle 130 may be streamed to contract executing VM 109 by a streaming service 134 installed at vehicle 130. Contract executing VM 109 may execute the one or more smart contracts based on the real-time event data received from streaming service 134. Similarly, the real-time event data from a first vehicle 130 may be streamed to a contract executing VM 136 of a second vehicle by the streaming service 134 of the first vehicle 130. The contract executing VM 136 of the second vehicle may execute the one or more smart contracts based on the real-time event data received from the streaming service 134. Execution of the smart contracts based on the real-time event data is described in greater detail below in reference to FIG. 2.

Vehicle 130 may include an electronic control unit (ECU) 132, such as a digital cockpit ECU, which may control various operations of vehicle 130. ECU 132 may include a processor, which may execute instructions stored in a memory of ECU 132 to implement the various operations. In some embodiments, ECU 132 may be powered by a power storage device of vehicle 130, such as a battery 139. Battery 139 may be a dedicated ECU battery, or battery 139 may be a specified battery, for example, for an input-output controller of ECU 132, whereby power to execute the instructions may be available if power is not available via other power sources of vehicle 130. In various embodiments, battery 139 may supply ECU 132 with sufficient power to operate when a motor or engine of vehicle 130 is not operating, and a main battery of vehicle 130 is not charged. For example, in some embodiments, battery 139 may supply sufficient power to ECU 132 to receive and install an OTA update when the motor or engine of vehicle 130 is not operating and/or and the main battery of vehicle 130 is not charged.

Communication module 138 may support wireless communication between vehicle 130 and other vehicles of vehicle fleet 142 and/or vehicle management system 102. The wireless communication may rely on one or more of various wireless technologies (e.g., radio frequency, infrared, near field communication (NFC), etc.). For example, a wireless connection may be established via a radio frequency (RF) link that supports bidirectional communication, whereby RF signals may be transmitted from a first vehicle 130 to a second vehicle 130 via communication module 138, and/or RF signals may be transmitted from the second vehicle 130 to the first vehicle 130 and received at communication module 138. Communication module 138 may communicate via a wireless local area network (LAN) or wide area network (WAN) using any past, present, or future communication protocol (e.g., BLUETOOTH™, USB 2.0, USB 3.0, etc.).

Vehicle 130 may include an OTA update system 133, which may maintain software running at vehicle 130 up to date. For example, the software may be running at ECU 132. Periodically, OTA updates to the software may be transmitted to vehicle 130. OTA update system 133 may include a blockchain 135, which may be a copy of blockchain 108. For example, OTA update system 133 may be installed at vehicle 130 at a time of manufacture, and a copy of blockchain 108 may be included in the installed OTA update system 133 at the time of manufacture. The OTA updates transmitted to vehicle 130 may be added to blockchain 135 at a time of installation, as described below in reference to FIG. 2. In other words, in some embodiments, each vehicle 130 of fleet 142 may store software version information and OTA updates for every vehicle 130 in fleet 142. The OTA updates transmitted to vehicle 130 may also be stored in a memory 137 of the OTA update system 133. In various embodiments, the OTA update may be downloaded in chunks, where the chunks may be stored in memory 137. After all the chunks of the OTA update have been downloaded, the OTA update may be verified during a blockchain validation procedure, and stored in blockchain 135. If the inclusion of the OTA update into the blockchain is validated, the OTA update may be installed at ECU 132. After the OTA updated is installed, the OTA update may be removed from memory 137.

A contract executing VM 136 of blockchain 135 may be configured to receive real time data from streaming service 134 and/or streaming services of other vehicles 130 of vehicle fleet 142, and execute one or more smart contracts stored on blockchain 135 based on the real time data. By including blockchain 135 in vehicle 130, a communication with vehicle management system 102 is not relied on for smart contract execution, whereby a lack of availability of vehicle management system 102 (e.g., due to unexpected downtime, or a lack of connectivity with vehicle 130) may not affect an updating of software of vehicle 130 by the one or more smart contracts.

In some embodiments, data regarding versions of software running at various vehicles 130 may be accessed by one or more regulatory authorities 140. Further, in some embodiments, the one or more regulatory authorities 140 may store a copy of blockchain 108 (and identical blockchain 135), and may access the version data via the stored copy.

Vehicle management system 102 may be operably/communicatively coupled to a user input device 120 and a display device 124. User input device 120 may comprise one or more of a touchscreen, a keyboard, a mouse, a trackpad, a motion sensing camera, or other device configured to enable a user to interact with and manipulate data within vehicle management system 102. In one example, user input device 120 may enable a user to release an update to software running at vehicle 130, which may be downloaded at vehicle 130 via communication module 138.

Display device 124 may include one or more display devices utilizing virtually any type of technology. In some embodiments, display device 124 may comprise a computer monitor on which data of vehicle 130, vehicle owner(s) 136, and/or vehicle operator(s) 138 may be displayed. Display device 124 may be combined with processor(s) 106, non-transitory memory 104, and/or user input device 120 in a shared enclosure, or may be peripheral display devices and may comprise a monitor, touchscreen, projector, or other display device known in the art, which may enable a user to and/or interact with various data stored in non-transitory memory 104.

By including copies of blockchain 108 at vehicle 130, the distributed ledger may be created, where a validity of software programs running at vehicle 130 may be verified by a plurality of copies of blockchain 108 at various vehicles 130, thus increasing a security of vehicle 130. Additionally, as an alternative to sending an OTA update from vehicle management system 102 to a plurality of vehicles 130 via wireless network 150, the OTA update may be sent from vehicle management system 102 to one vehicle 130, or a small number of vehicles 130, and the OTA update may be transferred from a blockchain 135 of the one vehicle 130 or small number of vehicles 130 to blockchains 135 of the plurality of vehicles 130 via vehicle-to-vehicle (V2V) communication. By using the V2V communication, a robustness of vehicle management system 102 to external factors may be increased For example, a power outage may make vehicle management system 102 unavailable to vehicle 130, whereby vehicle 130 may still be able to perform software updates via the V2V communication using OTA update system 133, and access to or execution of the smart contracts stored on blockchain 135 may not be affected by the power outage.

Referring to FIG. 2, an exemplary method 200 is shown for performing an OTA update of software running at a first vehicle, such as vehicle 130 of FIG. 1, where the OTA update is received at the first vehicle from a second vehicle located near the vehicle that has a more recent version of the software than the first vehicle. By performing the OTA update between the first vehicle and the second vehicle rather than between a vehicle management system (e.g., vehicle management system 102) and the vehicle, and efficiency of the OTA update may be increased. Additionally, a new version of the software may be installed in a secure manner by validating the new version against a blockchain stored at both of the first vehicle and the second vehicle, as described above. Method 200 may be executed by a ECU of the first vehicle, such as ECU 132 of vehicle 130 of FIG. 1. Additionally, some portions of method 200 may be executed via smart contracts by a contract executing VM embedded in a first blockchain of the first vehicle, such as contract executing VM 136 embedded in blockchain 135 of vehicle 130.

Method 200 begins at 202, where method 200 includes estimating and measuring vehicle operating conditions of the first vehicle. Vehicle operating conditions may be estimated based on one or more outputs of various sensors of the first vehicle (e.g., such as an oil temperature sensor, engine velocity or wheel velocity sensor, torque sensor, pressure sensor, etc). Vehicle operating conditions may include engine velocity and load, vehicle velocity, transmission oil temperature, exhaust gas flow rate, mass air flow rate, coolant temperature, coolant flow rate, engine oil pressures (e.g., oil gallery pressures), operating modes of one or more intake valves and/or exhaust valves, electric motor velocity, battery charge, engine torque output, vehicle wheel torque, etc., which may be controlled by one or more software applications running at the first vehicle, Estimating and/or measuring vehicle operating conditions may include determining whether the one or more software applications running at the first vehicle are functioning correctly, and/or whether updated versions of the one or more software applications are available. For example, estimating and/or measuring vehicle operating conditions may include sending a request to the vehicle management system to determine whether the updated versions of the one or more software applications are available. Additionally, estimating and/or measuring vehicle operating conditions may include determining whether the vehicle is being powered by an engine or an electric motor.

At 204, method 200 optionally includes determining whether an OTA update notification is received from the vehicle management system, via a wireless network (e.g., wireless network 150). In some embodiments, the vehicle management system may notify the first vehicle that an OTA update has been installed at one or more vehicles (e.g., of a vehicle fleet such as fleet 142) and is available for downloading from the one or more vehicles using V2V communication. The OTA update notification may be transmitted by a streaming service of the vehicle management system (e.g., streaming service 110). The OTA update notification may be received at a first contract executing VM of the first vehicle (e.g., contract executing VM 136).

In other embodiments, the OTA update notification may not be sent, and a determination of whether an OTA update is available may be made during the V2V communication, described below at steps 210-226.

If the notification of an OTA update is not received by the first contract executing VM of the first vehicle at 204, method 200 proceeds to 206. At 206, method 200 optionally includes continuing operation of first vehicle until an OTA update notification is received, and method 200 proceeds back to 204.

If the OTA update notification is received by the first contract executing VM of the first vehicle at 204, method 200 proceeds to 208. At 208, method 200 includes broadcasting a request for the OTA update to other vehicles in a vicinity of the first vehicle. Specifically, a first smart contract of the first blockchain of the first vehicle may be executed in response to receiving the OTA update notification, and the first smart contract may broadcast the request for the OTA update to the other vehicles. In other words, the first smart contract may be triggered by the notification, and may automatically execute a command to broadcast the request for the OTA update (e.g., without receiving a command from an operator of the first vehicle or a separate functional component (e.g., an ECU) of the first vehicle).

The first smart contract may broadcast the request for the OTA update to the other vehicles via a first streaming service of the first vehicle (e.g., streaming service 134 of vehicle 130 of FIG. 1). In various embodiments, the request for the OTA update may be broadcasted on a predetermined radio frequency (RF). Specifically, an RF signal may be generated by the first streaming service of the first vehicle, and the RF signal may be received at one or more second vehicles within a threshold distance of the first vehicle, where the threshold distance may be based on a strength of the RF signal. If a second vehicle is outside the threshold distance, the RF signal may not be received at the second vehicle. If the second vehicle is inside the threshold distance, the RF signal may be received at the second vehicle. Alternatively, in some embodiments, the request for the OTA update may not be broadcasted via the predetermined radio frequency, and the request may be wirelessly streamed by the streaming service over a network and/or via the Internet, such as, for example, via a cell phone network.

The RF signal (or wireless stream) including the request may be received from the first streaming service of the first vehicle by a second contract executing VM embedded in a second blockchain of the second vehicle. In various embodiments, the second contract executing VM may be listening at the predetermined radio frequency for other vehicles in a vicinity of the second vehicle, or may be listening for a predetermined protocol of the wireless stream. When the second contract executing VM of the second vehicle receives the request, a second smart contract of the second blockchain of the second vehicle may be executed. In other words, the second smart contract may be triggered by the request.

In some embodiments, the request for the OTA update broadcasted by the first vehicle may include data regarding one or more specific software applications running at the first vehicle for which the OTA update is requested. For example, the first vehicle may receive a notification an OTA update from the vehicle management system for a specific software application running at the first vehicle, and in response to receiving the notification, the first vehicle may request the notified OTA update from the second vehicle. In other embodiments, the request for the OTA update broadcasted by the first vehicle may be a generic request, and the generic request may include version information of one or more software applications running at the first vehicle.

In some embodiments, the second smart contract executed by the second contract executing VM of the second vehicle may be specific to a specific OTA update and/or a specific software application running at the first vehicle. For example, the specific OTA update may be indicated in the notification received from the vehicle management system. The second contract executing VM may receive an indication of the specific OTA update, or version information of the specific software application, and based on the version information of the specific software application, the second smart contract may determine if an OTA update is available at the second vehicle for the specific software application. For example, the version information may include a first version number of the software application of the first vehicle. If the first version number of the software application of the first vehicle is less than a second version number of a same software application of the second vehicle, it may be inferred that the second vehicle is operating with a more recent version of the software application, whereby an OTA update package may be available at the second vehicle to be downloaded by the first vehicle. The first version number transmitted in the request may be stored in and accessed from the first blockchain of the first vehicle by the first smart contract, and the second version number may be stored in and accessed from the second blockchain of the second vehicle by the second smart contract. Alternatively, it should be appreciated that both of the first version number and the second version number may be stored in and accessed from either of the first blockchain or the second blockchain, which are synchronized during periodic validations.

At 210, method 200 includes determining whether a second vehicle has responded to the request broadcasted by the first vehicle. The second vehicle may respond to the request when a second smart contract stored in the second blockchain of the second vehicle is executed (e.g., triggered) by the second contract executing VM, based on information included in the request. If the second smart contract is not triggered, the second vehicle may not respond to the first vehicle. For example, the second smart contract may not be executed as a result of the second version number of the software application not being greater than the first version number, from which it may be inferred that the second vehicle is not running a more recent version of the software application and therefore may not have the OTA update. Alternatively, if a second vehicle does not respond to the request at 210, it may be inferred that a second vehicle is not within the threshold distance of the first vehicle. If the second vehicle does not respond to the request at 210, method 200 proceeds to 212. At 212, method 200 includes continuing operation of the first vehicle until a second vehicle responds to the request of the first vehicle.

It should be appreciated that in some embodiments, the role of the second vehicle, or other neighboring vehicles described herein, may be performed by a stationary OTA update system installed within physical infrastructure proximate to the first vehicle. For example, the first vehicle may be parked in a lot, and an OTA update system may be installed at a building or communications installation located at the lot. When the first vehicle is parked in the lot, method 200 may be performed to manage an OTA update between the first vehicle and the OTA update system installed at the lot, using vehicle-to-infrastructure (V2X) communication rather than V2V communication.

If a second vehicle responds to the request at 210 (e.g., the second smart contract is executed in response to the request), it may be inferred that the second vehicle is within the threshold distance of the first vehicle and includes the OTA update, whereby method 200 proceeds to 214. When the second vehicle responds to the request, the response set by the second vehicle may be received by the first contract executing VM of the first vehicle. In response to receiving the request, the first contract executing VM may execute a second smart contract stored in the first block chain, where the second smart contract may include instructions for downloading the OTA update package from the second vehicle. The second smart contract may also include instructions for performing one or more transactions to add to the OTA update package to the first block chain of the first vehicle, and to verify the one or more transactions with blockchains installed at other vehicles, as described in greater detail below.

At 214, method 200 includes establishing a wireless connection with the second vehicle. In various embodiments, the wireless connection may be established between a first communication module of the first vehicle and a second communication module of the second vehicle. The wireless connection may be established one or more of various wireless technologies (e.g., radio frequency, infrared, near field communication (NFC), BLUETOOTH™, etc.), In accordance with instructions established in the second smart contract.

At 216, at the 200 includes initiating a download of an OTA update package from the second vehicle to the first vehicle. The OTA update package may be stored in the second blockchain of the second vehicle. In various embodiments, the OTA update package may be downloaded by the first vehicle in chunks, in accordance with instructions provided in the second smart contract. For example, a first chunk of the update package may be downloaded. After the first chunk is downloaded, a second chunk of the update package may be downloaded. After the second chunk is downloaded, a third chunk of the update package may be downloaded, and so on. In this way, if the connection is lost during downloading, previously downloaded chunks may be stored, and remaining chunks that have not been downloaded may be downloaded at a later time from a different vehicle. The downloaded chunks may be stored in a first memory (e.g., memory 137) of a first OTA update system of the first vehicle.

In some cases, a portion of the downloaded chunks may already be downloaded and stored in the first memory. For example, the portion of the downloaded chunks may have been previously downloaded from a different vehicle, and the different vehicle may have moved out of the threshold distance before a remaining portion of the downloaded chunks could be downloaded. Therefore, prior to initiating the download, the first OTA update system may check to see if one or more chunks of the download are already in the first memory. If the one or more chunks of the download are already in the first memory, the OTA update system may determine a last chunk downloaded, and begin the download at a subsequent chunk.

At 218, method 200 includes determining whether the OTA update package has been entirely downloaded. If at 218 it is determined that the update package has not been entirely downloaded, method 200 proceeds to 220. At 220, method 200 includes determining whether the second vehicle is still within the threshold distance. For example, the first vehicle may send a request for a subsequent chunk of the download. If the request is received at the second vehicle, it may be inferred that the second vehicle is still within the threshold distance. If at 220 it is determined that the second vehicle is still within the threshold distance, method 200 proceeds to 222. A 222, method 200 includes downloading the subsequent chunk, and method 200 proceeds back to 218. In this way, method 200 includes continuing to download additional chunks of the OTA update package until it is determined that the download is finished or the second vehicle is no longer within the threshold distance.

Alternatively, if at 220 it is determined that the first vehicle is no longer within the threshold distance (e.g., the request for the subsequent chunk is not received), and a subsequent chunk of the OTA update package cannot be downloaded, method 200 proceeds to 224. At 224, method 200 includes recording a last chunk downloaded at the first memory of the first OTA update system of the first vehicle. Method 200 proceeds to 226, where method 200 includes continuing vehicle operation using the current version of the software. The OTA update is not installed, and installation of the OTA update may be postponed until a third vehicle including the OTA update is within the threshold distance, and the remaining chunks may be downloaded from the third vehicle.

If at 218 it is determined that the OTA update package has been entirely downloaded, method 200 proceeds to 228. At 228, method 200 includes submitting a transaction to the first blockchain of the first vehicle to add the OTA update, in accordance with instructions provided in the second smart contract. When the transaction is submitted to the first blockchain, the transaction may be verified by a number of validating vehicles including other copies of the blockchain. Verifying the transaction may include validating the first blockchain against the other copies of the blockchain in accordance with a block validation procedure. In various embodiments, the number of validating vehicles may be a predetermined number that is less than a total number of vehicles in the vehicle fleet. For example, if there are 100 vehicles in the vehicle fleet, the number of validating vehicles may be 10. By verifying the transaction (e.g., validating the blockchain), an authenticity of the OTA update package may be ensured.

In some embodiments, validation of the blockchain may be performed by the validating vehicles over a wireless network, such as a cell phone network. The validation may be performed over the Internet. For example, in some embodiments, the first vehicle may download the OTA update from the second vehicle via V2V communication at a first time when the wireless network is not available, and the first vehicle may verify the transaction and/or validate and update the blockchain at a second time, when the wireless network is available. In other embodiments, the transaction may be verified by the validating vehicles via the V2V communication. For example, the first vehicle and the second vehicle may be parked in a lot near a plurality of other vehicles of a same vehicle fleet. The first vehicle may download the OTA update from the second vehicle via the V2V communication. The first vehicle may submit a transaction to add the OTA update to the blockchain at the first vehicle, and the transaction may be verified by one or more of the plurality of other vehicles via the V2V communication. After the transaction has been verified, the OTA update may be installed at the first vehicle. The copies of the blockchain at the plurality of other vehicles may then be updated and validated via the V2V communication. Other copies of the blockchain at vehicles not parked in the lot may be updated later. For example, the other copies may be updated by V2V communication when a respective vehicle enters into proximity with a vehicle including the updated blockchain, or the other copies may be updated and validated over a wireless network. In other embodiments, the OTA update may not be installed until after the blockchain at the first vehicle has been validated by the validating vehicles.

In some embodiments, the transaction may be performed and verified off-chain, and validated during a later blockchain update, similar to updates using the Lightning Network. For example, a channel for verifying the transaction may be established between the first vehicle and one or more other vehicles including a copy of the blockchain. The channel may be established via the V2V communication, or via a wireless network. The transaction may be verified on the channel by the one or more other vehicles at a first time. The copies of the blockchain installed at the one or more other vehicles, and copies of the blockchain installed at different vehicles not participating in the channel, may be updated and validated at a second, later time. In general, it should be appreciated that the transaction may be verified, and the copies of the blockchain may be updated and validated, by any relevant methods and/or using any relevant technologies known in the art without departing from the scope of this disclosure.

At 230, method 200 includes determining whether the transaction is verified by the other copies of the blockchain. If at 230 the transaction is verified by the other copies of the blockchain during blockchain validation, method 200 proceeds to 232. At 232, method 200 includes installing the OTA update, and method 200 ends. When the OTA update is installed, one or more files of the OTA update package may be deleted from the first memory.

Alternatively, if at 230 it is determined that the transaction was not verified by the other copies of the blockchain, method 200 proceeds to 226, where method 200 includes continuing operation using the current version of the software. The OTA update is not installed at the first vehicle. Additionally, a notification may be sent to the vehicle management system that the OTA update could not be verified and/or the first blockchain could not be validated against other copies of the blockchain. One cause of the transaction not being verified could be that the OTA update was maliciously altered prior to or during the download.

FIG. 3 shows an exemplary method 300 for providing an OTA update of a software program running at a second vehicle to a first vehicle, where the first vehicle and second vehicle are the same as the first vehicle and second vehicle of FIG. 2, respectively. Method 200 may be executed by a ECU of the second vehicle (ECU 132 of vehicle 130 of FIG. 1). Additionally, some portions of method 200 may be executed via smart contracts by a contract executing VM embedded in the blockchain of the first vehicle,

Method 300 begins at 302, where method 200 includes estimating and measuring vehicle operating conditions of the second vehicle. Vehicle operating conditions may be estimated based on one or more outputs of various sensors of the second vehicle (e.g., such as an oil temperature sensor, engine velocity or wheel velocity sensor, torque sensor, pressure sensor, etc). Vehicle operating conditions may include engine velocity and load, vehicle velocity, transmission oil temperature, exhaust gas flow rate, mass air flow rate, coolant temperature, coolant flow rate, engine oil pressures (e.g., oil gallery pressures), operating modes of one or more intake valves and/or exhaust valves, electric motor velocity, battery charge, engine torque output, vehicle wheel torque, etc., which may be controlled by one or more software applications running at the second vehicle. Estimating and/or measuring vehicle operating conditions may include determining whether the one or more software applications running at the second vehicle arc functioning correctly, and/or whether updated versions of the one or more software applications are available. For example, estimating and/or measuring vehicle operating conditions may include sending a request to the vehicle management system to determine whether the updated versions of the one or more software applications are available. Additionally, estimating and/or measuring vehicle operating conditions may include determining whether the second vehicle is being powered by an engine or an electric motor.

At 304, method 300 includes determining whether an OTA update request is received from the first vehicle. As described above in reference to FIG. 2, the OTA update request may be transmitted from the first vehicle to the second vehicle via V2V communication. Specifically, the OTA update request may be transmitted by the first streaming service (e.g., streaming service 134) of the first vehicle. The OTA update request may be received by a second contract executing VM of the second vehicle (e.g., contract executing VM 136). The second contract executing VM may be listening for the OTA update request at a specific radio frequency, or the second contract executing VM may identify the OTA update request via header data/metadata and/or protocol data included in the OTA update request.

If at 304 the OTA update request is not received, method 300 proceeds to 306, At 306, method 300 includes continuing operation of the second vehicle until an OTA request is received, and method 300 proceeds back to 304. Alternatively, if at 304 the OTA update is received by the second vehicle, method 300 proceeds to 308.

At 308, method 300 includes identifying a software application associated with the OTA update request, and comparing a first version number of the software application running at the first vehicle with a second version number of the software application running at the second vehicle. In some embodiments, the first version number may be transmitted within the OTA update request. In other embodiments, either or both of the first version number and the second version number may be retrieved from the second blockchain installed at the second vehicle.

Specifically, when the OTA update request is received by the second contract executing VM, a third smart contract stored in the second blockchain may be executed in response to receiving the OTA update request. In other words, the third smart contract may be triggered by the OTA update request, and executed automatically without receiving a command from an operator of the second vehicle or a separate functional component (e.g., an ECU) of the second vehicle.

At 310, method 300 includes determining whether an OTA update package is available at the second vehicle for downloading by the first vehicle. In various embodiments, instructions for determining whether the OTA update package is available at the second vehicle may be provided in the third smart contract. If the first version number is equal to the second version number, it may be inferred that the first vehicle and a second vehicle are both running the same version of the software application, whereby an OTA update package may not be available at the second vehicle for downloading by the first vehicle. Alternatively, if the first version number is less than the second version number, it may be inferred that the second vehicle is running a more recent version of the software application than the first vehicle, whereby an OTA update package may be available at the second vehicle for downloading by the first vehicle.

If at 310 it is determined that the OTA update package is not available at the second vehicle, method 300 proceeds to 312. At 312, method 300 includes sending a response to the first vehicle indicating that the OTA update package is not available at the second vehicle for downloading by the first vehicle, and method 300 ends. The response may be transmitted to the first vehicle in accordance with instructions stored in the third smart contract. If at 310 it is determined that the OTA update package is available at the second vehicle, method 300 proceeds to 314.

At 314, method 300 includes sending a response to the first vehicle indicating that the OTA update package is available at the second vehicle for downloading by the first vehicle. The response may be transmitted to the first vehicle in accordance with instructions stored in the third smart contract. Method 300 proceeds to 316.

At 316, method 300 includes establishing a wireless connection between the first vehicle and the second vehicle, and providing download access to the OTA update package to the first vehicle. Specifically, the wireless connection may be established between a first communication module of the first vehicle and a second communication module of the second vehicle (e.g., communication module 138 of FIG. 1), Establishment of the wireless connection may be initiated by the first vehicle (e.g., via the second smart contract), or by the second vehicle (e.g., via the third smart contract). After the wireless connection between the first communication module and a second communication module is established, the first vehicle may proceed to download the OTA update package to the first vehicle. As described above in reference to FIG. 2, the OTA update package may be downloaded in chunks, in accordance with instructions provided in the second smart contract of the first vehicle. Method 300 ends.

FIG. 4 shows a timeline 400 during updating of software running at a first vehicle 404, a second vehicle 406, and a third vehicle 408 of a vehicle fleet, by a vehicle management system (VMS) 402, which may be non-limiting versions of vehicle 130 of vehicle fleet 142 and VMS 102 of FIG. 1. First vehicle 404, second vehicle 406, and third vehicle 408 may be running a version 1.0 of the software. An update package is released by VMS 402 may be disseminated to first vehicle 404, second vehicle 406, and third vehicle 408 in accordance with interactions between the vehicles described on timeline 400, where time is indicated on a left side of timeline 400. The interactions between the vehicles are indicated by arrows between dotted lines associated with VMS 402, first vehicle 404, second vehicle 406, and third vehicle 408.

At a time t=1, first vehicle 404 is running version 1.0 of the software. At a time t=2, the OTA update package is downloaded from VMS 402 by first vehicle 404. The OTA update package may be downloaded via a wireless network, such as wireless network 150 of FIG. 1. In some embodiments, vehicle 404 may be located at an establishment of a manufacturer of vehicle 404, and the OTA update package may be downloaded from VMS 402 to first vehicle 404 via a private wireless network. In other embodiments, first vehicle 404 may be a vehicle in circulation in a region of VMS 402, and the OTA update package may be downloaded from VMS 402 via a public wireless network, over the Internet. At a time t=3, the update package is installed at first vehicle 404. At time t=4, first vehicle 404 is running version 2.0 of the software.

At a time t=5, second vehicle 406 enters into proximity with first vehicle 404, and a connection is made between first vehicle 404 and second vehicle 406. For example, the connection may be made between a first communication module 138 of first vehicle 404 and a second communication module 138 of second vehicle 406. In various embodiments, the connection may be made by a smart contract stored in a blockchain 135 of either or both of first vehicle 404 and second vehicle 406, and executed in a contract executing virtual machine 136 of a respective blockchain 135, as described above in reference to FIGS. 2 and 3.

At times t=6, 7, and 8, the OTA update package may be downloaded from first vehicle 404 to second vehicle 406 in chunks. For example, a first chunk of the OTA update package may be downloaded at time t=6; a second chunk of the OTA update package may be downloaded at time t=7; and a third chunk of the OTA update package may be downloaded at time t=8.

At a time t=9, the wireless connection between first vehicle 404 and second vehicle 406 may be lost. As a result of the connection being lost, downloading of the OTA update package from first vehicle to second vehicle 406 may end, where the update package may not have been fully downloaded. For example, the OTA update package may be divided into five chunks, and only three chunks may be downloaded prior to losing the connection. The three chunks may be stored in a memory of an OTA update system second vehicle 406, such as memory 137 of OTA update system 133 of FIG. 1.

At a time t=10, third vehicle 408 enters into proximity with first vehicle 404, and a connection is made between first vehicle 404 and third vehicle 408. For example, the connection may be made between the first communication module 138 of first vehicle 404 and a second communication module 138 of third vehicle 408. In various embodiments, the connection may be made by a smart contract stored in a blockchain 135 of either or both of first vehicle 404 and third vehicle 408, and executed in a contract executing virtual machine 136 of a respective blockchain 135

At times t=11-15, the OTA update package may be downloaded from first vehicle 404 to third vehicle 408 in chunks, By time t=15, all five of the chunks of the OTA update package may be downloaded to third vehicle 408. As a result of all five of the chunks of the OTA update package being downloaded, at time t=16, the OTA update package is installed at third vehicle 408. Installing the OTA update package at third vehicle 408 may include validating the OTA update package against the blockchain stored at third vehicle 408 and/or other blockchains stored at other vehicles including the same software. Validation of the OTA update package may occur as a result of a plurality of validating vehicles verifying a transaction to add the OTA update package to the blockchain. If the OTA update package is validated, the OTA update package may be installed at third vehicle 408, and if the OTA update package is not validated, the OTA update package may not be installed at third vehicle 408.

At a time t=17, as a result of installing the OTA update package, version 2.0 of the software is running at third vehicle 408.

At a time t=18, second vehicle 406 enters into proximity with third vehicle 408, and a connection is made between third vehicle 408 and second vehicle 406. For example, the connection may be made between first communication module 138 of third vehicle 408 and a second communication module 138 of second vehicle 406. In various embodiments, the connection may be made by a smart contract stored in a blockchain 135 of either or both of third vehicle 408 and second vehicle 406, and executed in a contract executing virtual machine 136 of a respective blockchain 135.

At times t=19 and 20, the remaining chunks four and five of the OTA update package may be downloaded from second vehicle 406 to third vehicle 408. As a result of all five of the chunks of the OTA update package being downloaded at second vehicle 406, at time t=21, the OTA update package is installed at second vehicle 406, Installing the OTA update package at second vehicle 406 may include validating the OTA update package against the blockchain stored at second vehicle 406 and/or other blockchains stored at other vehicles including a copy of the blockchain. At a time t=22, version 2.0 of the software is running at second vehicle 406.

In this way, the OTA update package may be transmitted from the VMS 402 to each of first vehicle 404, second vehicle 406, and third vehicle 408 via V2V communication between the vehicles. By transmitting the OTA update package via the V2V communication rather than from VMS 402, a use of resources of VMS 402 may be reduced, increasing an efficiency of VMS 402,

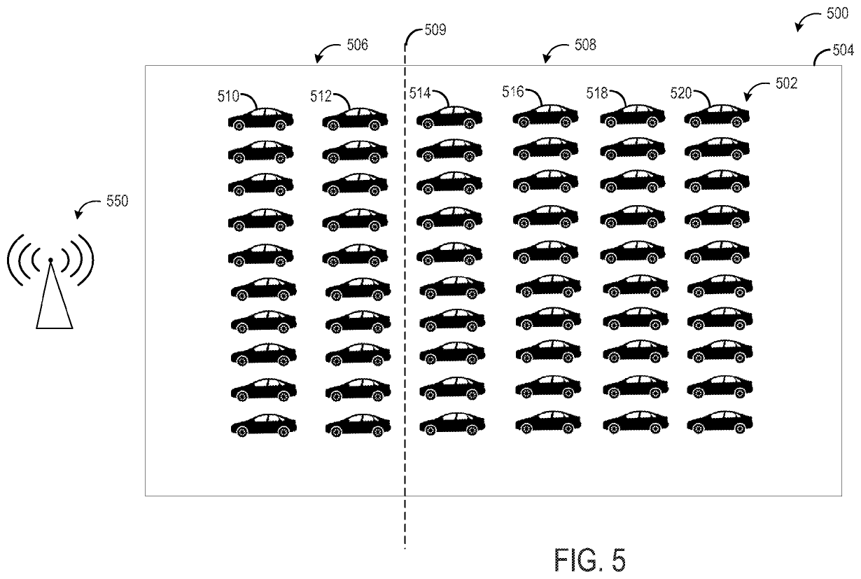

FIG. 5 shows one example of how the V2V communication may increase the efficiency of a VMS system, where a plurality of vehicles 502 (e.g., vehicles 130) are stored in a parking lot 504 of a manufacturer operating a VMS system. A wireless network 550 (e.g., network 150 of FIG. 1) may be installed on parking lot 504, where wireless network 550 may be a private wireless network of the manufacturer. A first portion 506 of the plurality of vehicles 502 may be connected to wireless network 550, and a second portion 508 may not be connected to wireless network 550. For example, second portion 508 may not be connected to wireless network 550 to increase a security of the vehicles 502 of second portion 508. In other words, malicious intrusions into the vehicles 502 of second portion 508 may be prevented by not connecting second portion 508 to wireless network 550. Alternatively, wireless network 550 may have a limited range indicated by a dashed line 509, and second portion 508 may be out of range of wireless network 550. It should be appreciated that the vehicles depicted in FIG. 5 are for illustrative purposes and FIG. 5 is not drawn to scale.

Prior to selling the vehicles, a new version of a software program relied on by the plurality of vehicles 502 may be generated. To install the new version of the software program at the plurality of vehicles 502, an OTA update package may be prepared. The OTA update package may be downloaded by one or more target vehicles of the plurality of vehicles, for example, via wireless network 550. The one or more target vehicles may include vehicles of the first portion 506, and may not include vehicles of second portion 508. For example, the one or more target vehicles may include a first vehicle 510 and a second vehicle 512, but may not include a third vehicle 514, a fourth vehicle 516, a fifth vehicle 518, and a sixth vehicle 520.

Each vehicle of the plurality of vehicles 502 not including the OTA update may broadcast a request for the OTA update via a respective streaming service installed at the vehicle (e.g., streaming service 134), via V2V communication. For example, the streaming service may be configured to broadcast the request at regular intervals. In some embodiments, the streaming service may be configured to broadcast the request in response to receiving a notification of the OTA update from the VMS, for example, via wireless network 550. The request may be received at a contract executing VM of a different vehicle of the plurality of vehicles 502, where the different vehicle is a neighboring vehicle within a threshold distance of the vehicle. The threshold distance may be maximum distance over which the V2V communication may operate. For example, a streaming service of vehicle 514 of the second portion 508 of vehicles may broadcast the request, and the request may be received at a first contract executing VM of vehicle 512. The request may also be received at a second contract executing VM of vehicle 516. The request may not be received by vehicles 510 and 518, which may be outside the threshold distance.

In response to receiving the request, the first contract executing VM may execute a first smart contract stored on a first blockchain of vehicle 512. The first smart contract may compare a first version number of the software program of the requesting vehicle 514 with a second version number of the software program of the receiving vehicle 512. The second version number may be greater than the first version number, as a result of vehicle 512 receiving the OTA update via wireless network 550. In response to the second version number being greater than the first version number, the first smart contract may send a first response, via a respective streaming service, to vehicle 514 indicating that the OTA update is available at vehicle 512 to be downloaded and installed by vehicle 514.

In response to receiving the request, the second contract executing VM may execute a second smart contract stored on a second blockchain of vehicle 516. The second smart contract may compare the first version number of the software program of the requesting vehicle 514 with a third version number of the software program of the receiving vehicle 516. The third version number may be equal to the first version number, as a result of vehicle 516 not receiving the OTA update via wireless network 550. In response to the third version number being equal to the first version number, the second smart contract may send a second response, via a respective streaming service, to vehicle 514 indicating that the OTA update is not available at vehicle 516 to be downloaded and installed by vehicle 514.

The first response and the second response may be received at a third contract executing VM at vehicle 514. The second response indicating that the OTA update is not available at vehicle 516 may not cause a smart contract to be executed. The first response indicating that the OTA update is available at vehicle 512 may cause a fourth smart contract to be executed by the third contract executing VM. The fourth smart contract may establish a wireless connection between vehicle 514 and vehicle 512 for the V2V communication, and initiate downloading of the OTA update from vehicle 512. The OTA update may be downloaded in chunks. When all of the chunks of the OTA update (e.g., an OTA update package) have been downloaded, the fourth smart contract may submit a transaction to a third blockchain installed at vehicle 514, to add the OTA update to the third blockchain. A blockchain validation procedure may be performed, where a plurality of validating vehicles having copies of the same blockchain may verify the transaction and verify that the third blockchain is identical to the copies of the same blockchain at the validating vehicles. In response to verifying the transaction and validity of the third blockchain, the OTA update may be added to the third blockchain, and the OTA update may be installed at vehicle 514.

Vehicle 514 may then receive a request for the OTA update from vehicle 516. Vehicle 514 may send a response to vehicle 516 indicating that the OTA update is available at vehicle 514 for download. The response may be received at the second contract executing VM of vehicle 516, which may execute a smart contract stored on the second blockchain of vehicle 516 to download the OTA update from vehicle 514, as described above. After the OTA update is installed at vehicle 516, vehicle 516 may respond to a request for the OTA update from vehicle 518, and vehicle 518 may download the OTA update from vehicle 516. In this way, the OTA update originally installed via wireless network 550 may be successively downloaded by vehicles not connected to wireless network 550 via the V2V communication, until the plurality of vehicles 502 have installed the OTA update. Thus, as a result of a small number of initial downloads via wireless network 550, the OTA update may be propagated through and installed at the plurality of vehicles 502, without each vehicle 502 having to download the OTA update directly from the VMS via wireless network 550. As a result, network traffic on the wireless network 550 may be reduced. Additionally, a first amount of time taken to install the OTA update at the plurality of vehicles 502 via the V2V communication may be faster than a second amount of time taken to install the OTA update at the plurality of vehicles 502 via direct downloads from the VMS system, as a result of a greater number of OTA update downloads being performed via the V2V communication in parallel. Further, because processing resources used for managing the downloads may be consumed at each vehicle of the plurality of vehicles 502 as opposed to the VMS, processing resources of the VMS may be freed up to perform other tasks, thereby increasing a performance and/or functioning of the VMS.

Additionally, a security of the OTA update may be increased, where prior to installing the OTA update, the OTA update may be added to a blockchain installed at a relevant vehicle and validated against versions of the OTA update installed at other vehicles and stored at copies of the blockchain installed the other vehicles. If the OTA update cannot be validated, it may be inferred that the OTA update is not identical to versions of the OTA updated installed at the other vehicles. For example, the OTA update may have been maliciously altered to affect or control an operation of the vehicle, or the OTA update may include a defect. In this way, defects may be identified prior to installing software, intrusions into software applications running at vehicles of a vehicle fleet may be reduced, and a performance of the vehicles may be maintained or increased.

An additional advantage of the systems and methods described herein is that a greater amount of information regarding versions of various software packages and various OTA updates installed at a plurality of vehicles may be stored in a distributed fashion across the plurality of vehicles. In other words, the VMS and each vehicle within it may include a copy of a common blockchain, where the common blockchain may include version information of the plurality of vehicles. As a result, the version information may be quickly and easily accessed from a single source. For example, the VMS may determine that a previous OTA update may include a defect. The VMS may consult its copy of the blockchain to determine which vehicles of the plurality of vehicles downloaded and installed the OTA update. The vehicles including the version of the OTA update with the defect may then be notified that a new version not including the defect should be downloaded to replace the defective version. Alternatively, the version information included on the blockchain may be used to determine a cause of a decrease in performance of a plurality of vehicles having a same version of installed software. In this way, defects in the software may be discovered and fixed more efficiently in comparison to scenarios where the version information is not stored in a distributed manner on the blockchain.

The technical effect of disseminating OTA updates to vehicle software via V2V communication and storing the OTA updates on a blockchain is that an amount of processing resources and network resources of a vehicle management system may be reduced, and a security of the OTA update may be increased.

The disclosure also provides support for an over-the-air (OTA) update system for a vehicle, the OTA update system comprising: a streaming service configured to request an OTA update from a second vehicle, a blockchain including a contract executing virtual machine (VM), the contract executing VM configured to execute, in response to receiving a response to the request from the second vehicle, a first smart contract stored on the blockchain including instructions that when executed, cause the contract executing VM to download the OTA update from the second vehicle, and install the OTA update at the vehicle. In a first example of the system, the smart contract includes further instructions for downloading the OTA update from the second vehicle that when executed, cause the contract executing VM to: establish a wireless connection between the vehicle and the second vehicle, download the OTA update from the second vehicle via the wireless connection, submit a transaction to add the OTA update to the blockchain, verify the transaction and validate the blockchain against a plurality of other copies of the blockchain installed at other vehicles, and in response to the transaction being verified, install the OTA update at the vehicle. In a second example of the system, optionally including the first example, the OTA update is requested from the second vehicle by a second smart contract, the second smart contract executed by the contract executing VM in response to the contract executing VM receiving a notification of an availability of the OTA update from a vehicle management system. In a third example of the system, optionally including one or both of the first and second examples, the OTA update is transmitted to and installed at the second vehicle by the vehicle management system via a wireless network. In a fourth example of the system, optionally including one or more or each of the first through third examples, the response to the request from the second vehicle indicates an availability of the OTA update at the second vehicle for downloading by the vehicle. In a fifth example of the system, optionally including one or more or each of the first through fourth examples, the request for the OTA update is sent by the streaming service, the response to the request is received by the contract executing VM, and the first smart contract is executed by the contract executing VM, all when the vehicle is not being operated by a driver. In a sixth example of the system, optionally including one or more or each of the first through fifth examples, the vehicle is not connected to a wireless network. In a seventh example of the system, optionally including one or more or each of the first through sixth examples, the vehicle is parked in a lot, and the second vehicle is parked within a threshold distance of the vehicle in the lot. In a eighth example of the system, optionally including one or more or each of the first through seventh examples, the smart contract includes further instructions that when executed, cause the contract executing VM to download the OTA update in chunks. In a ninth example of the system, optionally including one or more or each of the first through eighth examples,: a first number of chunks of the OTA update are downloaded from the second vehicle, the first number less than a total number of chunks of the OTA update, a remaining number of chunks of the OTA update are downloaded from a third vehicle, and in response to the remaining number of chunks being downloaded, the OTA update is installed at the vehicle.

The disclosure also provides support for a method for installing an over-the-air (OTA) update to a software application of a vehicle, the method comprising: broadcasting a request for the OTA update to other vehicles within a threshold distance of the vehicle via a streaming service, in response to a contract executing virtual machine (VM) embedded in a blockchain installed at the vehicle receiving a response to the request from a second vehicle of the other vehicles indicating an availability of the OTA update for downloading, executing a smart contract stored on the blockchain, and in accordance with the smart contract: establishing a wireless connection between the vehicle and the second vehicle, downloading the OTA update from the second vehicle via the wireless connection, submitting a transaction to add the OTA update to the blockchain, verifying the transaction against a plurality of other copies of the blockchain installed at other vehicles, in response to the transaction being verified, installing the OTA update at the vehicle. In a first example of the method, both of the vehicle and the second vehicle are parked and not connected to a wireless network. In a second example of the method, optionally including the first example, downloading the OTA update from the second vehicle via the wireless connection further comprises: downloading a first number of chunks of the OTA update from the second vehicle at a first time, in response to the second vehicle moving outside the threshold distance, downloading a remaining number of chunks of the OTA update from a third vehicle located within the threshold distance at a second time. In a third example of the method, optionally including one or both of the first and second examples, in a first condition, the transaction is verified against the plurality of other copies of the blockchain, and the OTA update is installed at the vehicle, and in a second condition, the transaction is not verified against the plurality of other copies of the blockchain, and the OTA update is not installed at the vehicle.

The disclosure also provides support for a method for updating software at a plurality of vehicles, the method comprising: installing an over-the-air (OTA) update system at each vehicle of the plurality of vehicles, the OTA update system including a streaming service configured to send an OTA update request to a different vehicle of the plurality of vehicles, and a blockchain including a contract executing virtual machine (VM) configured to receive OTA update requests from other vehicles of the plurality of vehicles, installing an over-the-air (OTA) update package at a first number of vehicles of the plurality of vehicles, the OTA update received from a vehicle management system via a wireless network and stored in a respective blockchain of each vehicle of the first number of vehicles, installing the OTA update package at a second, remaining number of vehicles of the plurality of vehicles, the OTA update package received from other vehicles of the plurality of vehicles via vehicle-to-vehicle (V2V) communication and stored in a respective blockchain of each vehicle of the second, remaining number of vehicles, the OTA update package verified against other blockchains stored at other vehicles of the plurality of vehicles prior to being installed, In a first example of the method, installing the OTA update package at a first vehicle of the second, remaining number of vehicles includes: receiving a notification from the vehicle management system that the OTA update package is available for downloading from a vehicle of the first number of vehicles, sending a request for the OTA update package to other vehicles of the plurality of vehicles via the streaming service of the first vehicle, in response to receiving a response to the request from a second vehicle at the contract executing VM of the first vehicle, executing a smart contract that: establishes a wireless connection between the first vehicle and the second vehicle, downloads the OTA update from the second vehicle via the wireless connection, submits a transaction to add the OTA update to the blockchain, verifies the transaction against a plurality of other copies of the blockchain installed at other vehicles, and in response to the transaction being verified, installing the OTA update at the first vehicle. In a second example of the method, optionally including the first example, the response received from the second vehicle is sent by the second vehicle in response to a first version number of the software included in the request being less than a second version number of the software running at the second vehicle, In a third example of the method, optionally including one or both of the first and second examples, the plurality of vehicles are parked in a parking lot of the vehicle management system, and the first number of vehicles is selected to minimize an amount of time taken to update the software of the plurality of vehicles. In a fourth example of the method, optionally including one or more or each of the first through third examples, a portion of the second, remaining number of vehicles are not connected to the wireless network as a result of being out of a range of the wireless network. In a fifth example of the method, optionally including one or more or each of the first through fourth examples, a portion of the second, remaining number of vehicles are not connected to the wireless network to increase a security of the second, remaining number of vehicles.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure,

1. An over-the-air (OTA) update system for a vehicle, the OTA update system comprising:
a streaming service configured to request an OTA update from a second vehicle;
a blockchain including a contract executing virtual machine (VM), the contract executing VM configured to execute, in response to receiving a response to the request from the second vehicle, a first smart contract stored on the blockchain including instructions that when executed, cause the contract executing VM to download the OTA update from the second vehicle, and install the OTA update at the vehicle.

2. The OTA update system of claim 1, wherein the smart contract includes further instructions for downloading the OTA update from the second vehicle that when executed, cause the contract executing VM to;
establish a wireless connection between the vehicle and the second vehicle;
download the OTA update from the second vehicle via the wireless connection;
submit a transaction to add the OTA update to the blockchain;
verify the transaction and validate the blockchain against a plurality of other copies of the blockchain installed at other vehicles; and
in response to the transaction being verified, install the OTA update at the vehicle.

3. The OTA update system of claim 1, wherein the OTA update is requested from the second vehicle by a second smart contract, the second smart contract executed by the contract executing VM in response to the contract executing VM receiving a notification of an availability of the OTA update from a vehicle management system.

4. The OTA update system of claim 3, wherein the OTA update is transmitted to and installed at the second vehicle by the vehicle management system via a wireless network.

5. The OTA update system of claim 3, wherein the response to the request from the second vehicle indicates an availability of the OTA update at the second vehicle for downloading by the vehicle.

6. The OTA update system of claim 1, wherein the request for the OTA update is sent by the streaming service, the response to the request is received by the contract executing VM, and the first smart contract is executed by the contract executing VM, all when the vehicle is not being operated by a driver.

7. The OTA update system of claim 1, wherein the vehicle is not connected to a wireless network.

8. The OTA update system of claim 3, wherein the vehicle is parked in a lot, and the second vehicle is parked within a threshold distance of the vehicle in the lot.

9. The OTA update system of claim 2, wherein the smart contract includes further instructions that when executed, cause the contract executing VM to download the OTA update in chunks.

10. The OTA update system of claim 9, wherein:
a first number of chunks of the OTA update are downloaded from the second vehicle, the first number less than a total number of chunks of the OTA update;
a remaining number of chunks of the OTA update are downloaded from a third vehicle; and
in response to the remaining number of chunks being downloaded, the OTA update is installed at the vehicle.

11. A method for installing an over-the-air (OTA) update to a software application of a vehicle, the method comprising:
broadcasting a request for the OTA update to other vehicles within a threshold distance of the vehicle via a streaming service;
in response to a contract executing virtual machine (VM) embedded in a blockchain installed at the vehicle receiving a response to the request from a second vehicle of the other vehicles indicating an availability of the OTA update for downloading, executing a smart contract stored on the blockchain, and in accordance with the smart contract:
establishing a wireless connection between the vehicle and the second vehicle;
downloading the OTA update from the second vehicle via the wireless connection;
submitting a transaction to add the OTA update to the blockchain;
verifying the transaction against a plurality of other copies of the blockchain installed at other vehicles;
in response to the transaction being verified, installing the OTA update at the vehicle.

12. The method of claim 11, wherein both of the vehicle and the second vehicle are parked and not connected to a wireless network.

13. The method of claim 11, wherein downloading the OTA update from the second vehicle via the wireless connection further comprises:
downloading a first number of chunks of the OTA update from the second vehicle at a first time;
in response to the second vehicle moving outside the threshold distance, downloading a remaining number of chunks of the OTA update from a third vehicle located within the threshold distance at a second time.

14. The method of claim 11, wherein:
in a first condition, the transaction is verified against the plurality of other copies of the blockchain, and the OTA update is installed at the vehicle; and
in a second condition, the transaction is not verified against the plurality of other copies of the blockchain, and the OTA update is not installed at the vehicle.

15. A method for updating software at a plurality of vehicles, the method comprising:
installing an over-the-air (OTA) update system at each vehicle of the plurality of vehicles, the OTA update system including a streaming service configured to send an OTA update request to a different vehicle of the plurality of vehicles, and a blockchain including a contract executing virtual machine (VM) configured to receive OTA update requests from other vehicles of the plurality of vehicles;
installing an over-the-air (OTA) update package at a first number of vehicles of the plurality of vehicles, the OTA update received from a vehicle management system via a wireless network and stored in a respective blockchain of each vehicle of the first number of vehicles;
installing the OTA update package at a second, remaining number of vehicles of the plurality of vehicles, the OTA update package received from other vehicles of the plurality of vehicles via vehicle-to-vehicle (V2V) communication and stored in a respective blockchain of each vehicle of the second, remaining number of vehicles; the OTA update package verified against other blockchains stored at other vehicles of the plurality of vehicles prior to being installed.

16. The method of claim 15, wherein installing the OTA update package at a first vehicle of the second, remaining number of vehicles includes:
receiving a notification from the vehicle management system that the OTA update package is available for downloading from a vehicle of the first number of vehicles;
sending a request for the OTA update package to other vehicles of the plurality of vehicles via the streaming service of the first vehicle;
in response to receiving a response to the request from a second vehicle at the contract executing VM of the first vehicle, executing a smart contract that.
establishes a wireless connection between the first vehicle and the second vehicle;
downloads the OTA update from the second vehicle via the wireless connection;
submits a transaction to add the OTA update to the blockchain;
verifies the transaction against a plurality of other copies of the blockchain installed at other vehicles; and
in response to the transaction being verified, installing the OTA update at the first vehicle,

17. The method of claim 16, wherein the response received from the second vehicle is sent by the second vehicle in response to a first version number of the software included in the request being less than a second version number of the software running at the second vehicle.

18. The method of claim 15, wherein the plurality of vehicles are parked in a parking lot of the vehicle management system, and the first number of vehicles is selected to minimize an amount of time taken to update the software of the plurality of vehicles.

19. The method of claim 15, wherein a portion of the second, remaining number of vehicles are not connected to the wireless network as a result of being out of a range of the wireless network.

20. The method of claim 15, wherein a portion of the second, remaining number of vehicles are not connected to the wireless network to increase a security of the second, remaining number of vehicles.
